(19) United States
(12) Patent Application Publication
(10) Pub. No.: US 2024/0419135 A1
(43) Pub. Date: Dec. 19, 2024

(54) CONDITIONING DATA FOR CONFIGURING SOFT SENSORS

(71) Applicant: HONEYWELL INTERNATIONAL INC., Charlotte, NC (US)

(72) Inventors: Sudhakar Kathari, Chikkakannalli (IN); Peter Hart, Johannesburg (ZA)

(21) Appl. No.: 18/208,901

(22) Filed: Jun. 13, 2023

(51) Int. Cl. G05B 13/04

(52) U.S. Cl. CPC G05B 13/041; G05B 13/048

(57) ABSTRACT

Approaches for conditioning one or more process variables for configuring soft sensors, are described. According to one example, a processor may receive unconditioned data comprising data points or process variables indicating one or more characteristics associated with a process. The unconditioned data may be supplemented with an auxiliary set of process variables on detecting one or more missing process variables within the unconditioned data. A modified unconditioned data may thus be obtained. Further, a conditioned set of process variables, empirically representing the one or more characteristics associated with the process, may be identified from within the modified unconditioned data. The conditioned set of process variables may be provided to a plurality of inferential modellers to configure one or more soft sensors. A soft sensor, from among the one or more soft sensors, may then be selected for predicting runtime conformance metric associated with an outcome of the process.

### BACKGROUND

With recent technological advancements, there have been developments of various solutions for process industries. For instance, different types of process control and automation solutions have been developed and implemented in chemical and petroleum industries for advanced monitoring and control of various operations being implemented therein. Such solutions help in controlling the execution of processes in a desired manner to ensure production safety and obtain preferred results or outputs, such as products having desired specifications. However, as products and processes become complex, monitoring and controlling such complex industrial processes becomes challenging.

### BRIEF DESCRIPTION OF FIGURES

Systems and/or methods, in accordance with examples of the present subject matter are now described and with reference to the accompanying figures, in which:

FIG. 1 illustrates a computing environment within a process industry, according to an example implementation of the present subject matter;

FIG. 2 illustrates a block diagram of a system, according to one example implementation of the present subject matter;

FIG. 3 illustrate a computing environment comprising the system, according to an example implementation of the present subject matter;

FIG. 4 illustrates a graphical representation of unconditioned data, according to one example implementation of the present subject matter;

FIG. 5 illustrates an exemplary bar graph illustrating relevance scores of different input variables, according to an example implementation of the present subject matter.

FIG. 6 illustrates an exemplary covariance matrix generated for different process variables present in modified unconditioned data, according to an example implementation.

FIG. 7 illustrates a line graph illustrating a comparison between a historical conformance metric and a test conformance metric, according to one example implementation of the present subject matter.

FIG. 8 illustrates a method for conditioning data for configuring one or more soft sensors, according to an example implementation of the present subject matter.

FIG. 9 illustrates a detailed explanation of the block 806 for performing the correlation analysis, according to an example implementation of the present subject matter.

FIG. 10 (comprising FIGS. 10A and 10B) illustrates a method for conditioning data for configuring the one or more soft sensors, according to one example implementation of the present subject matter.

FIG. 11 illustrates a computing environment implementing a non-transitory computer readable medium for modelling one or more soft sensors, according to an example implementation of the present subject matter.

### DETAILED DESCRIPTION

In recent years, various solutions have been developed for assistance in monitoring and optimizing processes being implemented in process industries. To perform such processes, different attributes or variables are generally monitored to evaluate the conformance of different characteristics associated with the processes being executed and products being generated. For instance, process quality variables, indicating conformity to an outcome of a process, may be monitored to determine whether quality and manufacturing processes are in conformance with acceptable limits. Accordingly, monitoring such key process quality variables effectively helps in ascertaining whether any modification in the performance of the process is required for quality control of the process and products being generated.

Generally, measurement of such key process quality variables is dependent on manual analysis of different characteristics associated with the performance of the process, and generally indicated using process variables. For example, in a process of separating methane from heavier hydrocarbons, the process variables may indicate characteristics, such as temperature and pressure, associated with the separation process. Such process variables may generally be based on data received from various field devices, such as process controllers, sensors, valves, and actuators, associated with the process. The process variables are manually analysed, for example by offline laboratory analysis, to estimate the process quality variables for ascertaining conformance of the process. Based on the estimation, it may be ascertained whether the outcome of the process is as per the expectations, or if any necessary changes are required to be made so that performance of the process or quality of the products may conform with a desired outcome.

The offline laboratory analysis may provide precise measurements of the process quality variables, however, there are various limitations in performing such analysis. For instance, due to manual sampling and analysis of process variables, it may not be feasible to frequently estimate the process quality variables. Such manual analysis have long sampling intervals and would generally lead to significant measurement delays, failing to meet real-time process control and monitoring requirements. In process industries, such delays may have a severe influence on quality of products, production of waste, and safety of operations. Therefore, frequent or real-time analysis of such key process quality variables may be of utmost importance within process industries for their efficient functioning.

To overcome such challenges, different types of data-driven solutions have been developed. For instance, machine learning techniques are being widely used for developing inferential models, or soft sensors, that may be used in the process industries to predict the process quality variables. The predictions may be based on temporal mappings between the process variables and the process quality variables observed in past. However, there are several challenges that may still exist. For example, the existing soft sensors are generally developed based on linear relationships between the process variables and the process quality variables. However, as the complexity of the industrial processes increases, relationships between the process variables and the process quality variables may change dynamically or in a non-linear manner. Therefore, soft sensors being developed based on linear relationships may not be able to accurately estimate the process quality variables when the process variables and the process quality variables may change dynamically. Therefore, challenges arise when the complexity of the processes increases and the linear relationships fail to predict the output.

Further, accuracy of predictions being done by the data-driven solutions may majorly be dependent on quality and completeness of data being used for modelling such solutions or being provided to such solutions for generating predictions. The data, for example a set of the process variables, obtained from the field devices may include various anomalies. For instance, the set of the process variables may include junk, missing process variables, and redundant process variables. The set of process variables may thus indicate erroneous, incomplete, or biased characteristics. Configuring the data-driven solutions based on such data may cause the data-driven solutions to form erroneous relationships, for example, between the missing process variables and the process quality variables. Such relationships may lead to less accurate predictions, thereby misleading control operations for the industrial processes. Therefore, prediction quality of the data-driven solutions may be affected by different anomalies present in the set of process variables.

The present subject matter relates to techniques for conditioning data for configuring one or more soft sensors to infer process quality variables. According to one exemplary embodiment, the present subject matter discloses a system for conditioning a set of process variables and configuring one or more soft sensors based on the conditioned set of process variables for accurately inferring the process quality variables. In one example implementation, the system may receive unconditioned data comprising, in one example, the set of process variables indicating one or more characteristics associated with a process. The set of process variables may indicate characteristics, for example, temperature, pressure, volume, speed, rotation per minute, and flow rate.

The unconditioned data may then be conditioned to enhance its suitability for accurate prediction of the process quality variables, hereinafter interchangeably referred to as runtime conformance metric. In one example, the unconditioned data may be pre-processed to minimize anomalies present in unconditioned data. For instance, the unconditioned data may be analysed to determine one or more missing process variables and presence of anomalous variables, i.e., outliers within the unconditioned data. Absence of some process variables or presence of outliers may affect quality of the unconditioned data and thereby affecting accuracy of the predictions being generated on basis of such data. Thus, on ascertaining presence of the outliers and missing process variables, the unconditioned data may be supplemented with an auxiliary set of process variables to replace the outliers or the missing variables within the unconditioned data. In one example, the auxiliary set of process variables may be determined based on an average of the one or more process variables present in the unconditioned data. Thus, the auxiliary set of process variables may conform with the one or more process variables present in the unconditioned data. A modified unconditioned data, comprising the one or more process variables and the auxiliary set of process variables, may thus be obtained. The one or more process variables and the auxiliary set of process variables may hereinafter collectively be referred to as the one or more process variables.

The modified unconditioned data may further be processed for determining one or more process variables relevant for predicting the runtime conformance metric. In one example, each of the one or more process variables, present in the modified unconditioned data, may be analysed to filter the process variables that may be relevant for accurately predicting the runtime conformance metric. Also, in one example, a correlation analysis may be performed for each of the one or more process variables present in the modified unconditioned data. By the correlation analysis, a correlation among the one or more process variables may be determined. The correlation analysis may help in identifying one or more process variables indicating redundant and interrelated characteristics associated with the process. Therefore, the relevant and uncorrelated process variables may be filtered from the modified unconditioned data and obtained as a conditioned set of process variables.

The conditioned set of process variables may then be provided to a plurality of inferential modellers for configuring one or more soft sensors. The plurality of inferential modellers may be, for example, different types of machine learning models and deep learning models. The inferential modellers may use the conditioned set of process variables for configuring the one or more soft sensors. Along with the conditioned set of process variables, the laboratory analysis data, comprising temporal relation between process variables and historical process quality variables that may have been observed in the past for the process, may also be provided to the inferential modellers to capture linear as well as non-linear relationships between the process variables and the process quality variables, i.e., the runtime conformance metric. Thus, the one or more soft sensors, using the conditioned set of process variables and the historical conformance metric, may be modelled by the inferential modellers to capture linear and non-linear relationships and accordingly generate predictions for the runtime conformance metric for the process.

Further, based on the conditioned set of process variables, each of the one or more soft sensors may generate a test conformance metric. Based on the test conformance metric, each of the soft sensors may be validated. For example, the test conformance metric predicted by each of the soft sensors may be compared with the historical conformance metric in order to determine the soft sensor that generated the most proximate conformance metric as compared to the historical conformance metric. The soft sensor that generated the most proximate conformance metric may then be selected for being deployed for predicting conformance metrics during the runtime of the process, referred to as the runtime conformance metric.

The present subject matter may thus provide techniques for predicting the process quality variables with enhanced accuracy. As performance of the data-driven solutions may majorly depend on quality of data being provided, providing a conditioning set of process variables, comprising relevant and uncorrelated set of process variables, may enhance modeling of the soft sensors and thereby the predictions being generated. Further, by using uncorrelated data, the soft sensors may be configured with a variety of process variables, each indicating a distinct characteristic associated with the process. The soft sensors may thus be capable of generating predictions for a wide range of process variables. Further, using the conditioned set of process variables along with the offline laboratory analysis data, the inferential modellers may be capable of configuring the one or more soft sensors to capture linear as well as non-linear relationship between the process variables and the process quality variables. The soft sensors may thus be capable of tackling the dynamically changing relationships between the process variables and the process quality variables.

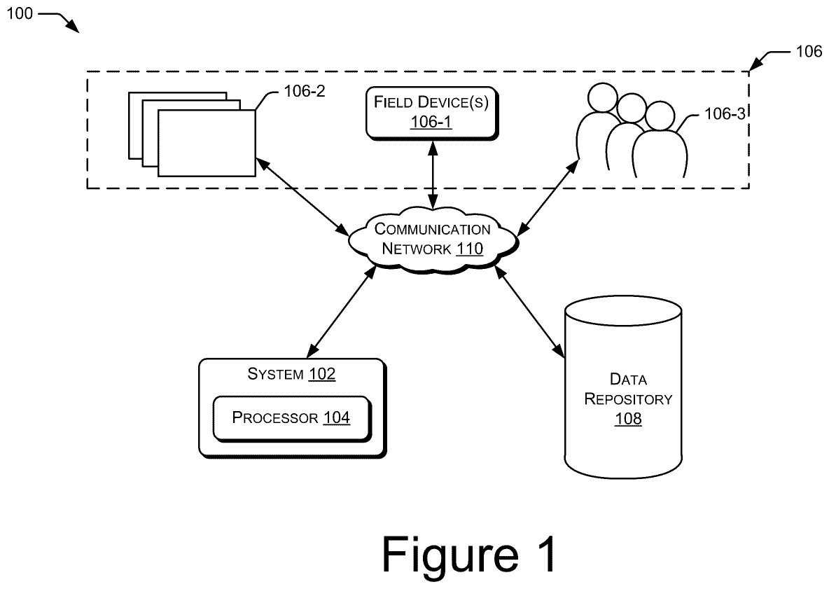

The present subject matter is further described with reference to FIGS. 1 to 11. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a computing environment 100 within a process industry, according to an example implementation of the present subject matter. Process industries may be, for example, industries where processes related to production of materials may occur. Examples of the process industries may include, but are not limited to, chemical industries, petroleum industries, food and beverage processing industries, power plants, textile industries, steel manufacturing industries, and refineries.

In one example implementation, the computing environment 100 may include a system 102, comprising a processor 104, a plurality of data sources 106, and a data repository 108. In one example, the system 102, the plurality of data sources 106, and the data repository 108 may be communicably coupled with each other over a communication network 110. The communication network 110 may be a wireless network, a wired network, or a combination thereof. The communication network 110 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 110 may include various network entities, such as transceivers, gateways, and routers. In an example, the communication network 110 may include any communication network that uses any of the commonly used protocols, for example, Hypertext Transfer Protocol (HTTP), and Transmission Control Protocol/Internet Protocol (TCP/IP).

The system 102 may be configured for conditioning data and configuring one or more soft sensors based on conditioned data. In one example, the system 102 may receive data from the plurality of data sources 106 over the communication network 110. The data may be raw or unconditioned data comprising a set of process variables. In one example, each process variable, present in the set of process variables, may be a data point. The data point, in one example, may be a value or measure indicative of one or more characteristics or operational parameters associated with a process being implemented in, or by, the process industry. For example, in a process of generating electricity, the process variables may be measurements indicating a number of rotations per minute (RPM) of a generator. Such process variables may generally be based on data received from the plurality of data sources 106. Examples of the plurality of data sources 106 may include, but are not limited to, one or more field devices 106-1, laboratory analysis data 106-2, and one or more users 106-3.

In one example, the one or more field devices 106-1 may be devices associated with the process being implemented in the process industry. Examples of the one or more field devices 106-1 may include, but are not limited to, process controllers, sensors, valves, and actuators. The one or more field devices 106-1 may generate data indicative of characteristics associated with the process and may thus be sources of data points. For example, in a process of separating methane from heavier hydrocarbons, a temperature sensor may sense an operating temperature and a pressure sensor may sense an operating pressure for the separation process. The sensors may accordingly generate data points over time indicating the characteristic, i.e., the operating temperature and pressure for the process.

In one example, the laboratory analysis data 106-2 may be a set of historical data observed over a period of time, comprising a temporal relationship between the process variables, an output of a process, and conformance of the output of the process, i.e., historical conformance metric. In one example, the historical conformance metric may be a quality relevant variable indicating the quality of the process or outcome of the process observed in past. In one example, the laboratory analysis data 106-2 may have been obtained by conducting a manual analysis of the processes and the associated data points or process variables. For instance, the processes being implemented within the process industry may have been analyzed and the process variables may have been obtained, for example from the field devices 106-1 or from the manual analysis of the process, and manually processed to compute the historical conformance metric. The laboratory analysis data 106-2 may thus include timestamps indicating a time when the process variables were observed, and the historical conformance metric observed for such process variables. Therefore, a time-based, i.e., temporal, relationship between the process variables, output of the process, and historical conformance metric may be stored within the laboratory analysis data 106-2.

Further, in one example, the raw or unconditioned data may be provided by the one or more users 106-3. The one or more users 106-3 may be, for example, staff or operators associated with the process. In another example, the one or more users 106-3 may be remotely located users. The one or more users 106-3 may provide the raw or unconditioned data comprising the set of process variables associated with the process being implemented within the process industry. For example, the one or more users 106-3 manually provide the process variables that may have been obtained manually or from the field devices 106-1 associated with the process.

In one example, the unconditioned data provided by the plurality of data sources 106 may be communicated to the system 102. In another example, the unconditioned data may be provided to the data repository 108 for being stored therein. The data repository 108 may act as a data library that may store the unconditioned data received from the plurality of data sources 106. In one example, the unconditioned data may be stored in form of one or more tables. The data repository 108 may be a large database infrastructure or a collection of several databases that collect, manage, and store data for analysis, sharing, and reporting. In one example, the data repository 108 may be implemented by one or more physically linked storage devices. In another example, the data repository 108 may include multiple interlinked storage devices distributed across different geographic locations. In yet another example, the data repository 108 may be hosted on a cloud-based platform.

On receiving the unconditioned data, the processor 104 of the system 102 may initiate conditioning of the unconditioned data. In one example, the unconditioned data may first be pre-processed by the processor 104 to minimize anomalies present in the unconditioned data. For instance, the unconditioned data may be analysed by the processor 104 to determine one or more missing process variables and the presence of outlier process variables within the unconditioned data. In one example, the missing process variables and the outlier process variables may be missing data points and outlier data points, respectively, in the unconditioned data.

On ascertaining the presence of the outlier process variables and missing process variables, the unconditioned data may be supplemented with an auxiliary set of process variables to replace the outliers or the missing variables. A modified unconditioned data, comprising the one or more process variables and the auxiliary set of process variables, may thus be obtained. The one or more process variables and the auxiliary set of process variables may hereinafter collectively be referred to as one or more process variables. The modified unconditioned data may then be processed by the processor 104 for determining the one or more process variables that may be relevant for predicting the runtime conformance metric. The processor 104 may also perform a correlation analysis for each of the one or more process variables and the auxiliary set of process variables to identify one or more uncorrelated process variables. Therefore, the relevant and uncorrelated process variables may be filtered from the modified unconditioned data and obtained as a conditioned set of process variables.

The conditioned set of process variables may then be provided to a plurality of inferential modellers for configuring one or more soft sensors. The inferential modellers may be, for example, different types of machine learning models and deep learning models. The inferential modellers may use the conditioned set of process variables, along with the laboratory analysis data 106-2, for configuring the one or more soft sensors for predicting runtime conformance metrics for the process.

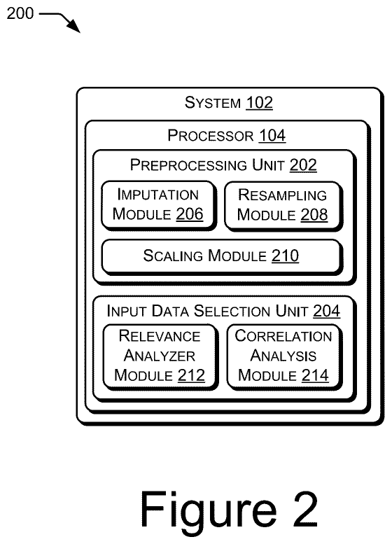

FIG. 2 illustrates a block diagram 200 of the system 102, according to one example implementation of the present subject matter. In one example, the system 102 may be a computing system having one or more physical computing systems geographically distributed at same or different locations. In another example, one or more components of the system 102 may be hosted virtually, for example, on a cloud-based platform. In yet another example, the system 102 may be a stand-alone system located inside the process industry. The system 102 may be used, in one example, for conditioning data and configuring one or more soft sensors. For instance, the system 102 may be used in the process industries for conditioning data, such as the process variables, and configuring the one or more soft sensors for predicting runtime conformance metric, as will be discussed below.

In one example implementation, the system 102 may include a processor, such as the processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, logic circuitries, and/or any other devices that manipulate signals and data based on computer-readable instructions.

The processor 104 may include, in one example, a preprocessing unit 202 and an input data selection unit 204. The preprocessing unit 202 may be configured to receive and analyze data, for instance, a set of the process variables for anomalies, such as junk, outliers, and missing process variables. In one example, the preprocessing unit 202 may include an imputation module 206 for analyzing the set of process variables for anomalies and accordingly replacing the anomalies with one or more auxiliary process variables, as will be discussed below. The preprocessing unit 202 may further include a resampling module 208 for resampling the set of process variables and a scaling module 210 for scaling the set of process variables to enhance compatibility of the set of process variables for further processing.

The input data selection unit 204 may further process the set of process variables to identify relevant or important process variables. In one example, the input data selection unit 204 may include a relevance analyzer module 212 and a correlation analysis module 214. The relevance analyzer module 212 may, in one example, identify one or more process variables that may be relevant for configuring one or more soft sensors. From the identified one or more process variables, the correlation analysis module 214 may identify, in one example, process variables that may be uncorrelated with each other.

The preprocessing unit 202 and the input data selection unit 204 may be hardware-based subunits of the processor 104. For example, the preprocessing unit 202 and the input data selection unit 204 may be microprocessors, microcomputers, microcontrollers, digital signal processors, central processing units, state machines, logic circuitries, and/or any other devices that manipulate signals and data based on computer-readable instructions.

In one example, the preprocessing unit 202 and the input data selection unit 204 may be implemented by software-based modules. For example, the processor 104 may store the preprocessing unit 202 and the input data selection unit 204 as one or more functions that may be called by the processor 104. In one example, the preprocessing unit 202 and the input data selection unit 204 may be implemented by a combination of hardware-based modules and software-based modules.

In one exemplary operation, the processor 104 may receive unconditioned data. In one example, the unconditioned data may be raw or unprocessed data that may be received from the plurality of data sources 106. In another example, the unconditioned data may be received from the data repository 108. In one of the other examples, the unconditioned data may be received from the plurality of data sources 106 and the data repository 108 over the communication network 110.

The unconditioned data may include a set of process variables. Each process variable, present in the set of process variables, may be, for example, a data point. The data points may be values or measurements indicating one or more operational parameters or characteristics associated with a process being implemented in, or by, the process industry. The set of process variables may be values or measurements indicating characteristics, for example, temperature, pressure, volume, speed, RPM, and flow rate. In another example, the data points or process variables may be indicative of one or more characteristics associated with a device involved in the process being implemented within the process industry. The data points may hereinafter interchangeably be referred to as process variables.

In one example, the process variables may be continuous data points, i.e., data points having infinite values, such as numeric values. Such continuous process variables may indicate measurements of, for example, temperature and pressure within a boiler. In another example, the process variables may be categorical variables which are generally not numerical and may have a finite number of categories. Such categorical process variables may indicate, for example, a type of material. For instance, the process variable may indicate the type of material as iron. In another example, the categorical process variables may indicate a state. For example, categorical process variables may indicate YES/NO and ON/OFF.

Further, the unconditioned data may be in any form. In one example, the unconditioned data may be in the form of a table comprising the set of process variables or data points arranged in one or more rows and columns. In another example, the unconditioned data may be in the form of multiple interlinked tables comprising the set of process variables distributed among the tables. In yet another example, the unconditioned data may be in the form of an array comprising the set of process variables.

The set of process variables present in the unconditioned data may be raw or unprocessed. It may therefore be possible that the unconditioned data may include missing data points, outlier data points, or other anomalies. For instance, the unconditioned data may include some missing data points that may not have been captured by, for example, the field devices 106-1 and some data points that may have errors and may thus be outliers as compared to other data points present in the unconditioned data. In one example, a temperature sensor may generate data points, say after every 10 minutes, indicating a temperature associated with a process. However, if the temperature sensor fails to generate the data point, say at the 30^{th} minute, the data point may be missing or may be indicated as, for example, NaN (Not a Number) in the unconditioned data. Similarly, it may also be possible that the temperature sensor may sense temperature at, say at the 50th minute, and generate an erroneous data point indicating an extreme or junk value of the temperature. The data point may thus be an outlier, as compared to other data points generated by the temperature sensor, and may thus be present in the unconditioned data. The missing data points and outlier data points may hereinafter interchangeably be referred to as missing process variables and outlier process variables.

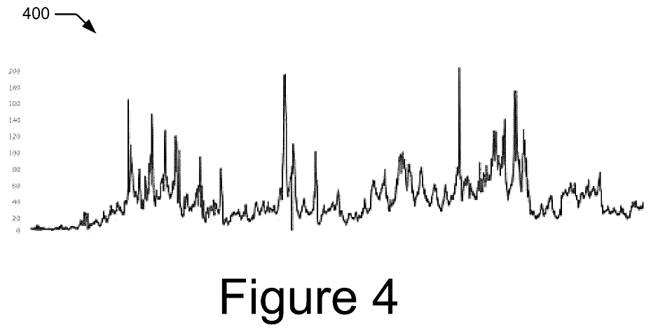

An illustrative example of the unconditioned data has been illustrated in FIG. 4. FIG. 4 illustrates a graphical representation 400 of the unconditioned data, according to one example implementation of the present subject matter. The graphical representation 400 exemplarily illustrates the unconditioned data comprising the process variables, using a line graph, associated with the process being implemented within the process industry. As can be observed from the exemplary illustration, the unconditioned data may include process variables that may vary over a significant range. For example, some process variables may be missing and may be closer to the 0 point marked on the Y-axis. Whereas, some process variables may be anomalous or inconsistent with the other process variables. For instance, as can be observed from the graphical representation 400, significant spikes may indicate outlier process variables in the unconditioned data that may be extremely different than the other process variables present in the unconditioned data. Therefore, it may be possible that the unconditioned data may include process variables spanning across a wide range and including various anomalies. Therefore, the processor 104, on receiving the unconditioned data, may pre-process or cleanse the unconditioned data to enhance its quality and processability.

In one example, the preprocessing unit 202 of the processor 104 may process the unconditioned data for minimizing anomalies. For instance, the imputation module 206 may analyse the unconditioned data to determine one or more process variables missing in the unconditioned data. Generally, the missing process variables or data points may be indicated as, for example, null, NaN (Not a Number), blank spaces, or other known special characters in the set of process variables. The imputation module 206 may scan the unconditioned data to identify the presence of such characters within the unconditioned data, and thereby identify the missing process variables in the unconditioned data. For instance, the imputation module 206 may scan each column, either randomly or in a specific order, of the one or more tables to identify one or more missing process variables.

Once the missing process variables are identified, the imputation module 206 may initiate the imputation process. For instance, the imputation module 206 may impute the one or more missing process variables using a machine learning algorithm. In one example, the imputation module 206 may use a Random Forest (RF) based algorithm. In the RF-based algorithm, the missing process variables may be imputed using, for example, a miss forest-based algorithm. In miss forest-based algorithm, the missing process variables may temporarily be replaced with its mean (for continuous process variables) or its most frequent class (for categorical process variables). For example, the missing values may be filled temporarily by the mean of respective columns for continuous process variables and most frequent process variables data for categorical process variables.

Once the missing process variables are temporarily replaced in the unconditioned data, the unconditioned data may be divided into mainly two data sets. For example, the process variables that were initially present in the unconditioned data may be randomly selected and used as a training data set and the temporarily replaced missing process variables may be used as a test data set. The training data set and the test data set may then be fed to the RF-based algorithm for determining the process variables that may be imputed for the missing process variables.

In one example, the RF-based algorithm may, at first, divide the training data set into multiple subsets, also known as bootstrapping. Using each of the subsets, at least one decision tree may be constructed. Each decision tree may be a combination of nodes and leaves. Each decision tree may start at a single point (or main node) which then branches (or splits) in at least two directions and may lead to the formation of further nodes and leaves. For instance, each node may include a process variable and a condition, say statistical condition (like greater than and less than), associated with the process variable. Result of the condition may be used for making a decision on how the branches of the tree may be divided. For example, if the condition defined in the node stands true (a YES), the branch may extend towards right. However, if the condition defined in the node stands false (a NO), the branch may extend towards left. The branching may continue until each tree yields a result. For example, each decision tree may yield 0 or NO and 1 or YES at the end. Each branch may thus offer different possible outcomes, incorporating a variety of decisions and chance events until a final outcome is achieved.

Once the decision trees have been formed and the results have been yielded, the temporarily replaced missing process variables present in the test data set may be fed to each of the decision trees. For example, each of the temporarily replaced missing process variables may be fed to each of the decision trees. Accordingly, the temporarily replaced missing process variables may traverse through the nodes and the leaves. Based on the process variables present in the nodes and the statistical conditions defined therein, the temporarily replaced missing process variables may proceed to traverse towards left or right branches and a result may finally be obtained from each of the decision trees. For example, considering one of the temporarily replaced missing process variables, each of the decision trees may yield a YES or NO for that temporarily replaced missing process variable. Each tree's result may indicate, as per that tree, whether that temporarily replaced missing process variable would be suitable for replacing the missing process variable. Aggregation of the results may then be performed. In aggregation, vote of each tree (YES or NO) may be considered. If a majority of voting results in YES, that temporarily replaced missing process variable may be considered for replacing the missing process variable in the unconditioned data. Similarly, the process may be repeated for all other missing process variables until all, or at least a majority of them, are identified and replaced. The temporarily replaced missing process variables that replace the missing process variables may hereinafter interchangeably be referred to as auxiliary set of process variables.

In one example, the unconditioned data may further be analysed for ascertaining the presence of at least one outlier process variable within the set of process variables. The at least one outlier process variable may be anomalous from other one or more process variables present in the set of process variables. For instance, the outlier process variables may be data points that may be extremely distinct from the other process variables, or other data points, present in the unconditioned data. In one example, the anomaly may be ascertained by statistically analysing each of the process variables present in the set of process variables. For example, a mean may be computed for all the process variables. All the process variables may then be, sequentially or randomly, compared with the mean. If the difference between a process variable and the mean is determined to be more than a predefined threshold difference, the process variable may be ascertained as outlier process variable. In one example, the outlier process variable may be imputed with temporarily replaced missing process variable, as discussed above. In another example, the outlier process variable may be removed from the set of process variables.

In another example, a decision tree-based machine learning algorithm may be used for ascertaining the presence of the outliers. For example, an isolation forest algorithm may be used. The unconditioned data may be fed to the isolation forest-based algorithm. The algorithm may split unconditioned data into multiple random subsets, each comprising one or more process variables. The subsets may then be assigned to a decision tree. Branching of the tree may start by selecting a random variable, from among the one or more process variables. Further branching may be done based on a random threshold value. In one example, the random threshold value may be a value within a threshold range of minimum and maximum values of the selected process variable. If the process variable, or value of the process variable, is determined to be less than the random threshold value, it goes to the left branch else to the right branch. Thus, a node leads to formation of left and right branches. This process may continue recursively till each of the process variables is completely isolated or a predefined maximum branching or depth is reached. Similarly, more than one tree can also be formed.

Once the algorithm runs through the unconditioned data, each process variable present therein may be traversed through all the trees, formed above, and the algorithm may filter the process variables which may have taken fewer steps than other process variables to be isolated. For example, an anomaly score may be computed based on the length of the process variable traverses to be isolated. Based on the score, the process variable may be filtered or identified as an outlier process variable.

The outlier process variables may then be supplemented with the auxiliary set of process variables. The auxiliary set of process variables, in one example, may be obtained using the RF-based algorithm. Similarly, other techniques may also be used to detect the missing process variables and the outlier process variables. The modified unconditioned data, comprising the process variables and the auxiliary set of process variables may thus be obtained. The above discussed imputation examples are for exemplary purposes. Other known imputation techniques may also be used. For example, a multivariate imputation using chained equations (MICE) algorithm and other decision tree-based or ensemble-based algorithms may be used for detecting and imputing the missing process variables and the outlier process variables.

In one example implementation, performing imputation of the missing process variables and the outlier process variables may be controllable. In one example, the decision to perform the imputation of the missing process variables and the outlier process variables may be dependent on state of an imputation function and an outlier detection function, respectively. In one example, the imputation module 206 may define the imputation function for performing imputation and the outlier detection function for detecting presence of outliers. State of the imputation function and the outlier detection function may define whether imputation of the process variables is to be performed. For instance, if impute state of the imputation function is YES, the imputation module 206 may ascertain that the unconditioned data is to be analysed for detecting missing process variables and imputation is to be performed. However, if the impute state of the imputation function is NO, the imputation module 206 may ascertain that the unconditioned data is to be analysed for detecting missing process variables and the missing process variables are to be removed from the unconditioned data. Similarly, if the outlier state of the outlier detection function is YES, the imputation module 206 may ascertain that the unconditioned data is to be analysed for presence of the outlier process variables and imputation is to be performed. However, if outlier state of the outlier detection function is NO, the imputation module 206 may ascertain that the unconditioned data is not to be analysed for detecting presence of the outlier process variables.

In one example, state of the imputation function and the outlier detection function may be defined to be YES by default. However, the state of the imputation function and the outlier detection function may be controllable, for example, by one or more users, such as the one or more users 106-3. In one example, the one or more users 106-3 may control the states of the imputation function and the outlier detection function through a user interactive interface (not shown). The user interactive interface may be, for example, an interface being rendered on a web page or by a software application on a user device associated with the one or more users 106-3. The user interactive interface may be accessible over the communication network 110. By interacting with the user interactive interface, the one or more users 106-3 may either enable or disable the imputation function and the outlier detection function.

Once the missing process variables and the outlier process variables, or at least a majority thereof, have been removed or replaced, the modified unconditioned data may be obtained. The modified unconditioned data may include the set of process variables and the auxiliary set of process variables. For the sake of brevity, the set of process variables and the auxiliary set of process variables may collectively be referred to as the set of process variables or one or more process variables.

In one example, the modified unconditioned data may be further processed for resampling and scaling the one or more process variables present therein. In one example, the imputation module 206 may share the modified set of process variables with the resampling module 208. The resampling module 208 may resample the modified unconditioned data by arranging the one or more process variables into one or more samples or subsets. The resampling may be performed, for example, by drawing repeated samples of the process variables from the modified unconditioned data. In one example, the resampling may be done based on a resampling factor. In one example, the resampling factor may be defined by the one or more users 106-3 using the user interactive interface. In another example, the resampling factor may be a predefined resampling factor. In one example, the resampling may be done by bootstrapping, as discussed above.

The modified unconditioned data, having subsets of process variables, may then be scaled based on a scaling factor. In one example, the resampling module 208 may send the modified unconditioned data, having subsets of process variables, to the scaling module 210. The scaling module 210 may perform scaling of the subsets to obtain samples or subsets of desired size or scale. In one example, scaling may be performed for making the subsets present in the modified unconditioned data fit or compatible with requirements for further processing. For example, the subsets in the modified set of process variables may have sample sizes suitable for performing correlation, as will be discussed. The modified unconditioned data, that has been scaled, may then be provided to the input data selection unit 204 by the scaling module 210.

The input data selection unit 204 may select relevant and uncorrelated inputs, i.e., process variables from the modified unconditioned data. In one example, the relevance analyzer module 212 may determine one or more process variables that may be relevant or highly important for predicting the runtime conformance metric. Identifying the relevant or highly important process variables may enhance prediction speed as lesser, and only relevant, process variables would require processing.

The relevance may be analysed, in one example, by using tree-based models. The tree-based models may help in identifying the process variables that may be important or suitable for being used in modelling the one or more soft sensors. The tree-based models may also have capability to capture non-linear relationships among the process variables. In one example, the tree-based model may be the RF-based algorithm. In the RF-based algorithm, the modified unconditioned data may be divided into a training data set and a test data set and multiple decision trees may be formed, as discussed above. The RF-based algorithm has multiple in-built features for statistically computing relevance or importance of process variables based on the decision trees.

In one example, the RF-based algorithm may statistically compute a Gini impurity score, also known as Mean Decrease in Impurity (MDI) score, for each of the process variables to identify relevant process variables with RF-based algorithm. For instance, a Gini impurity score may be computed for each of the process variables present in the nodes of the decision trees. Gini Impurity score or MDI score may indicate importance of each process variable as a sum over a number of splits (across all trees for that process variable), proportionally to the number of samples it splits. In other words, the process variables that lead to more splits in the decision tree may be important and may have a lower Gini impurity score, hereinafter interchangeably referred to as relevance score.

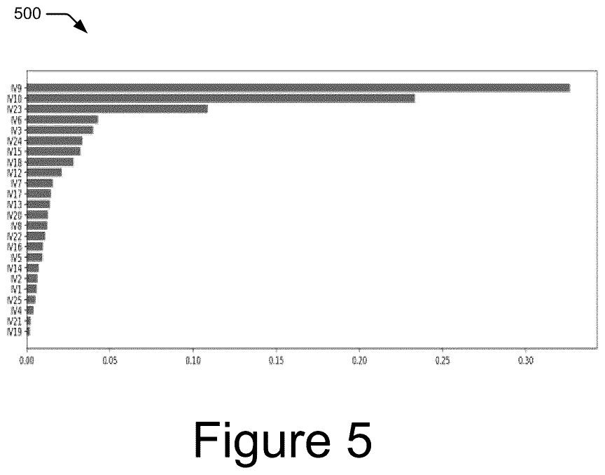

In another example, the RF-based algorithm may identify the relevant process variables by computing permutation importance, also known as Mean Decrease in Accuracy (MDA). In permutation importance, the RF-based algorithm may measure relevance or importance of a process variable by observing how random shuffling of the process variables in the test data set may influence prediction performance of the RF algorithm-based model, i.e., the decision trees formed based on the training data set. In other words, the RF-based algorithm may examine the impact on the model's predictive performance when a particular process variable is randomly shuffled or permuted. To assess this impact, each process variable may be individually shuffled, and the model's performance may be statistically measured using a loss function, for example, a mean squared error (MSE). By comparing the model's performance before and after shuffling the process variable, the RF-based algorithm may statistically quantify the change in performance, hereinafter referred to as the relevance score. The process variables that significantly decrease the model's performance when shuffled may be considered as important for accurate predictions. Based on these relevance scores obtained from the permutation approach, the process variables may be ranked. FIG. 5 illustrates an exemplary bar graph 500 illustrating relevance scores of different input variables (IV), i.e., the process variables. In the bar graph 500, Y-axis illustrates different process variables and the X-axis illustrates relevance score. The process variables have been arranged based on their relevance score. As can be observed, the process variable having the highest relevance score is indicated on first, or at top, followed by the process variables having comparatively less relevance scores.

The process variables with higher relevance scores may be considered more relevant for predictions, as they may have a stronger influence on the soft sensor's predictive accuracy. Based on the relevance score, the relevant process variables may be selected. In one example, the relevance score, of each process variable, may be compared with a threshold relevance score for identifying the process variables suitable for being used in modelling the one or more soft sensors. The process variables having the relevance score more than the threshold relevance score may be identified as the relevant process variables. For example, the process variables having relevance score of more than 0.1 may be selected as the relevant process variables. Thus, based on the bar graph representation 500, the top 3 process variables (IV9, IV10, and IV23) may be selected as the relevant process variables. The modified unconditioned data may now include only the identified relevant process variables.

In one example, a correlation analysis may further be performed for each of the one or more process variables present in the modified unconditioned data to identify uncorrelated process variables. In one example, the correlation analysis may be a statistical analysis used to measure the strength of relationship between process variables present in the modified unconditioned data and compute their association. By the correlation analysis, a correlation between the one or more process variables may thus be determined. The correlation analysis may also help in identifying one or more process variables that may be redundant, i.e., indicating similar characteristics associated with the process, within the modified unconditioned data.

The correlation analysis may be performed by the correlation analysis module 214. In one example, the correlation analysis module 214 may perform the statistical analysis to determine a correlation between each of the one or more process variables present in the modified unconditioned data. The correlation analysis may also be performed using any other conventionally known technique. In one example, the correlation analysis module 214 may statistically perform a covariance analysis for determining relationships between process variables, and thereby identify uncorrelated process variables. For example, the covariance analysis may be performed by using any of the conventionally known mathematical equations. In one example, the covariance analysis may be performed by following exemplary equation:

$$Covarience = \frac{Σ ( ( x - \overline{x} ) ( y - \overline{x} ) )}{n} \qquad ( 1 )$$

where x indicates a process variable, y indicates another process variable, x indicates a mean of all the process variables, and n indicates a total number of process variables.

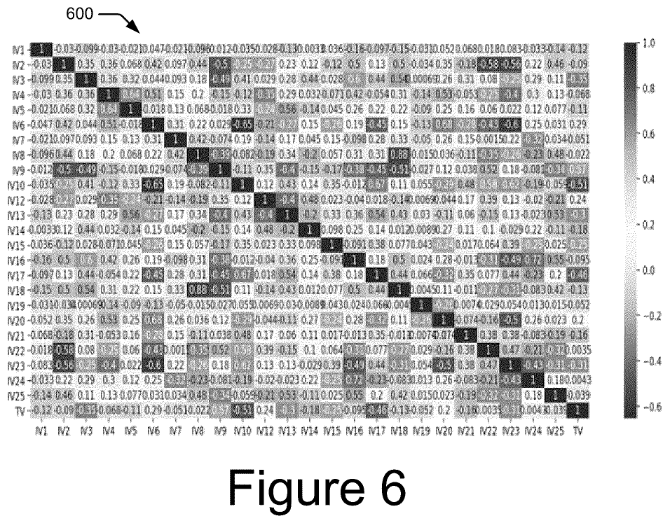

The sign of the covariance may indicate whether the process variables change in the same direction. For example, if the sign is positive, the process variables being compared may change in the same direction. However, if the sign is negative, the process variables being compared may change in different directions. Further, a covariance value of zero indicates that the process variables being compared may be completely independent of each other. Therefore, the statistical analysis may indicate an extent of correlation among the one or more process variables present in the modified unconditioned data. FIG. 6 illustrates an exemplary covariance matrix 600 generated for different the process variables present in the modified unconditioned data, according to an example implementation. In the covariance matrix 600, a range of the covariance may be observed from +1 to −1. In one example, +1 and −1 may indicate that the pair of process variables may have a strongly positive or strong negative correlation, respectively, with each other. Further, the diagonal of the matrix 600 indicates the covariance between each process variable and itself, thus being +1.

Once the covariance for each of the process variables present in the modified unconditioned data is determined, the covariance (ranging from +1 to −1, and hereinafter interchangeably referred to as a correlation score) may be compared with a threshold correlation score. Based on the comparison, the one or more uncorrelated process variables, from the modified unconditioned data, may be selected to form a conditioned set of process variables. That is, the process variables having correlation score more than the threshold correlation score may be determined as highly correlated and may not be selected to form the conditioned set of process variables. However, the process variables having the correlation score less than the threshold correlation score may be determined to be less, or uncorrelated, and may thus be selected to form the conditioned set of process variables.

As exemplarily illustrated in the matrix 600, there is no strong correlation between the process variables, IV9, IV10, and IV23. Thus, the conditioned set of process variables comprising the relevant and uncorrelated process variables (for example, IV9, IV10, and IV23) may be obtained. Further, as the process variables indicate one or more characteristics associated with the process, the conditioned set of process variables may be capable of empirically representing the one or more characteristics associated with the process.

In one example, the conditioned set of process variables may then be provided to a plurality of inferential modellers. The inferential modellers may be, for example, different types of machine learning engines and deep learning engines. Based on the conditioned set of process variables, each of the inferential modellers may configure one or more mathematical models, i.e., soft sensors for predicting the conformance metric for the process, as will be discussed. In one example, the runtime conformance metric may be associated with an outcome of the process. For example, the runtime conformance metric may indicate a quality of a product being generated by the process during its operation.

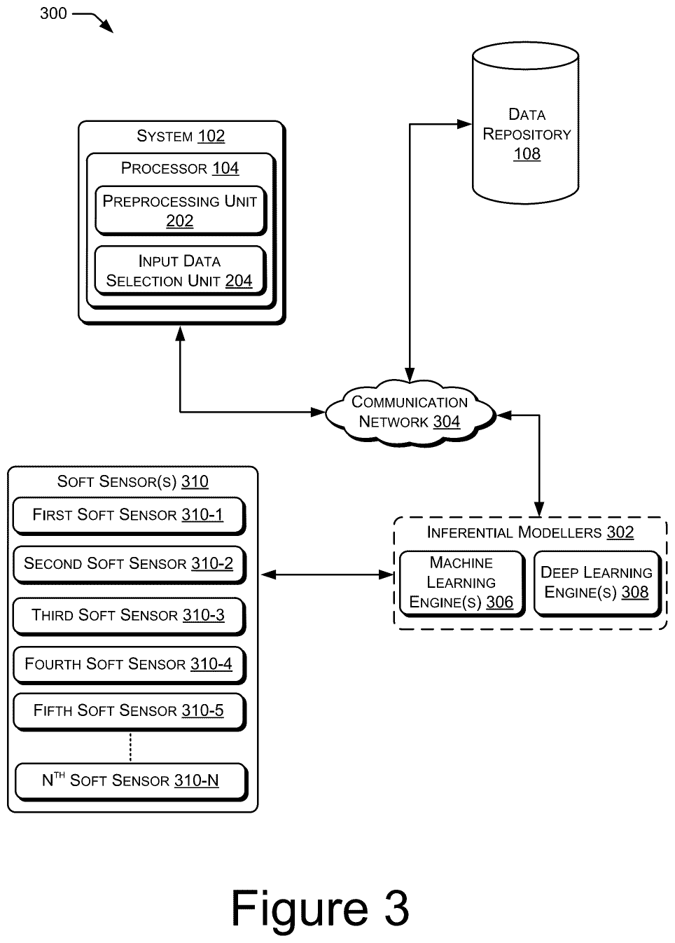

FIG. 3 illustrates a computing environment 300 comprising the system 102, according to an example implementation of the present subject matter. In one example, the computing environment 300 may be located within a process industry, as also disclosed in the computing environment 100. The computing environment 300 may include the system 102 and the data repository 108. In one example, the computing environment 300 may also include a plurality of inferential modeller(s) 302.

In one example, the system 102, the data repository 108, and the inferential modeller(s) 302 may be communicably coupled with each other over a communication network 304. In one example, the communication network 304 may be similar to the communication network 110, illustrated in FIG. 1. In another example, the communication network 304 may be different than the communication network 110. The communication network 110 may be a wireless network, a wired network, or a combination thereof. The communication network 110 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 110 may include various network entities, such as transceivers, gateways, and routers. In an example, the communication network 110 may include any communication network that uses any of the commonly used protocols, for example, Hypertext Transfer Protocol (HTTP), and Transmission Control Protocol/Internet Protocol (TCP/IP).

As previously discussed in one example, the data repository 108 may receive the unconditioned data from a plurality of data sources, such as the plurality of data sources 106. For example, the data repository 108 may receive unconditioned data from the field device(s) 106-1. In one example, the field devices 106-1 may generate unconditioned data, comprising one or more process variables, indicating characteristics associated with an industrial process.

The data repository 108 may also store laboratory analysis data, such as the laboratory analysis data 106-2. In one example, the laboratory analysis data 106-2 may be a set of historical data observed over a period of time. The laboratory analysis data 106-2 may include a temporal relationship between the process variables, the outcome of an industrial process, and conformance of the output of the industrial process, i.e., historical conformance metric observed in past for the industrial process. The laboratory analysis data 106-2 may have been obtained, in one example, by performing offline analysis of different industrial processes. By analyzing the industrial process, process variables associated with the industrial process may be obtained with timestamps. For example, the processes being implemented within the process industry may be manually analyzed and the process variables may accordingly be obtained, such as from the field devices 106-1 or from manual analysis of the process. The process variables may then be manually processed to compute the historical conformance metric associated with the observed process variables. In one example, the historical conformance metric may be indicative of an outcome associated with the industrial process. For example, the historical conformance metric may be a metric or a process quality variable indicating quality of the industrial process, or the outcome obtained from the industrial process. The outcome may be in the form of a product or a result obtained on completion of the industrial process. The laboratory analysis data 106-2 may thus include timestamps indicating a time when the process variables were observed, and the historical conformance metric were computed for such process variables. Therefore, a time-based, i.e., temporal, mapping or relationship between the process variables and the historical conformance metric may be stored within the laboratory analysis data 106-2.

The data repository 108 may also receive the raw or unconditioned data from the one or more users 106-3. The one or more users 106-3 may be, for example, one or more users associated with management of the industrial process. The one or more users 106-3 may provide the raw or unconditioned data comprising the set of process variables associated with the industrial process being implemented within the process industry. For example, the one or more users 106-3 manually provide the process variables that may have been obtained manually or from the field devices 106-1 associated with the process. In one example, the one or more users 106-3 may also manually provide the laboratory analysis data 106-2 for being stored in the data repository 108. The data repository 108 may thus be a data library that may store the unconditioned data and the laboratory analysis data received from the plurality of data sources 106.

In one example, the unconditioned data may be communicated to the system 102 from the data repository 108 over the communication network 304. On receiving the unconditioned data, the system 102 may initiate conditioning of the unconditioned data. In one example, the unconditioned data may first be pre-processed to minimize anomalies present in unconditioned data. As previously discussed, the unconditioned data may be processed for detecting and imputing missing process variables and outlier process variables. On ascertaining presence of the anomalies, the unconditioned data may be supplemented with the auxiliary set of process variables to replace the anomalies within the unconditioned data. As previously discussed, different type of tree-based algorithms may be used for supplementing the auxiliary set of process variables. The modified unconditioned data, comprising the one or more process variables and the auxiliary set of process variables, may thus be obtained.

The modified unconditioned data may then be processed for determining one or more process variables that may be relevant for predicting runtime conformance metrics associated with the industrial process. In one example, the runtime conformance metric may be associated with an outcome of the industrial process. For example, the runtime conformance metric may indicate a quality parameter associated with the industrial process, indicating a quality of the outcome obtained from the industrial process, such as a product. As discussed above in one example, the RF-based algorithm may be used for determining one or more process variables and the one or more auxiliary process variables that may be relevant or important for predicting the runtime conformance metric.

The system 102 may also perform a correlation analysis for each of the one or more process variables present in the modified unconditioned data to identify one or more relevant and uncorrelated process variables. As discussed above in one example, the uncorrelated process variables may be identified by performing a statistical analysis. The identified relevant and uncorrelated process variables may then be filtered from the modified unconditioned data and obtained as a conditioned set of process variables.

In one example implementation, the conditioned set of process variables may be provided to the plurality of inferential modeller(s) 302. In one example, the plurality of inferential modeller(s) 302 may include one or more machine learning engine(s) 306 and one or more deep learning engine(s) 308. Examples of the one or more machine learning engine(s) 306 may include, but are not limited to, a Linear Model (LM), random forest (RF) based model, and extreme gradient boosting (XGBoost) model. Further, examples of the one or more deep learning engine(s) 308 may include, but are not limited to, neural network-based models, such as multilayer perceptron (MLP), long short-term memory (LSTM) and gated recurrent unit (GRU).

In one example, the conditioned set of process variables may be provided along with the laboratory analysis data 106-2. As previously discussed, the laboratory analysis data 106-2 may include the temporal mapping between the process variables and the historical conformance metric.

In one example, the conditioned set of process variables and the laboratory analysis data 106-2 may be used by the inferential modeller(s) 302 for configuring one or more soft sensor(s) 310. In one example, the conditioned set of process variables and the laboratory analysis data 106-2 may divided mainly into two subsets, i.e., a training subset and a testing subset. The training subset may include majority of the conditioned set of process variables and the laboratory analysis data 106-2, while the testing subset may include a comparatively less conditioned set of process variables and the laboratory analysis data 106-2.

The training subset may be provided to the machine learning engine(s) 306 and the deep learning engine(s) 308. The machine learning engine(s) 306 and the deep learning engine(s) 308 may learn relationships and patterns between the data present in the training subset. For example, the machine learning engine(s) 306 and the deep learning engine(s) 308 may determine relationships and patterns between the process variables and target values, i.e., the historical conformance metrics temporally associated with the process variables. In one example, the machine learning engine(s) 306 may learn linear relationships between the input (the process variables) and the output (the historical conformance metrics).

Whereas, as the deep learning engine(s) 308 may include neural network architectures, the deep learning engine(s) 308 may capture complex trends and strong nonlinear relationships among process variables and the historical conformance metrics. For example, the neural network architecture may include one or more hidden layers that may perform nonlinear transformations of the inputs (the process variables) provided to the deep learning engine(s) 308. The one or more hidden layers may generally include functions, such as mathematical functions, to form non-linear complex relationships between the process variables and the historical conformance metric.

In one example, a plurality of machine learning engine(s) 306 and the deep learning engine(s) 308 may be trained. For example, by default, at least three machine learning engines 308 (such as LM, RF based model, and XGBoost model) and at least three deep learning engines 308 (such as MLP, LSTM, and GRU) may be trained. In one example, a number of machine learning engine(s) 306 and the deep learning engine(s) 308 to be trained may be defined by the one or more users 106-3 using the user interactive interface. The one or more users 106-3 may be able to define whether only the machine learning engine(s) 306 are to be trained, or only deep learning engine(s) 308 are to be trained, or both the machine learning engine(s) 306 and the deep learning engine(s) 308 are to be trained. Based on input from the one or more users 106-3, the machine learning engine(s) 306 and the deep learning engine(s) 308 may be trained.

Once the machine learning engine(s) 306 and the deep learning engine(s) 308 have been trained, each of the trained machine learning engine(s) 306 and the deep learning engine(s) 308 may create or configure at least one soft sensor(s) 310. The soft sensor(s) 310 may be, in one example, a mathematical model formed based on the relationships learned by the machine learning engine(s) 306 and the deep learning engine(s) 308 between the process variables and the historical conformance metrics. The soft sensor(s) 310 may be so configured that on providing an input to the soft sensor(s) 310, the soft sensor(s) 310 may generate an output (i.e., the runtime conformance metric) that may conform with the historical conformance metrics.

In one example, for N measurements of m process variables (i.e., input variables, (u1, u2, . . . , um)), and the historic conformance metric (i.e., output variable, (y)), the inferential modeller(s) 302 may configure the soft sensor(s) 310 that may relate the output and input variables by the following exemplary equation (2).

$$y = f ( {u}_{1} , {u}_{2} , … , {u}_{m} ) \qquad ( 2 )$$

where f represents a model form (structure), which can be linear, nonlinear, static, and dynamic.

Similarly, each of the machine learning engine(s) 306 and the deep learning engine(s) 308 may configure their respective soft sensor(s) 310. For example, the machine learning engine(s) 306 may configure a first soft sensor 310-1 and the deep learning engine(s) 308 may configure a second soft sensor 310-2 and a N^{th} soft sensor 310-N, where N is a natural number. In one example, there may be same number of soft sensor(s) 310 as the number of machine learning engine(s) 306 and the deep learning engine(s) 308 being trained. For example, the LM-based machine learning model may configure the first soft sensor 310-1, the RF-based model may configure the second soft sensor 310-2, the XGBoost model may configure a third soft sensor 310-3, the MLP-based deep learning model may configure a fourth soft sensor 310-4, the LSTM-based deep learning model may configure a fifth soft sensor 310-5, and the GRU based deep learning model may configure the N^{th} soft sensor 310-N. In yet another example, the inferential modeller(s) may configure one or more soft sensors 310.

Once each of the machine learning engine(s) 306 and the deep learning engine(s) 308 configures its soft sensor(s) 310, the testing subset may be provided to each of the soft sensor(s) 310. For example, one or more process variables present in the testing subset may be provided as input to the first soft sensor 310-1, the second soft sensor 310-2, the third soft sensor 310-3, the fourth soft sensor 310-4, the fifth soft sensor 310-5, and the N^{th} soft sensor 310-N. Each of the soft sensors may accordingly generate an output, i.e., a test conformance metric, based on the conditioned set of process variables (i.e., the process variables present in the test subset) and the historical conformance metric.

Further, each of the test conformance metrics may be statistically compared with their corresponding historical conformance metrics, the historical conformance metrics being associated with the process variables present in the test subset that were provided to the soft sensors. For the statistical comparison, in one example, a mean squared error (MSE) may be determined between the test conformance metrics and their associated historical conformance metrics. Exemplary values of the MSE for each soft sensor 310 have been indicated below in Table 1.

TABLE 1

| First | Second | Third | Fourth | Fifth | N^{th} |
|---|---|---|---|---|---|
| Soft | Soft | Soft | Soft | Soft | Soft |
| Sensor | Sensor | Sensor | Sensor | Sensor | Sensor |
| 310-1 | 310-2 | 310-3 | 310-4 | 310-5 | 310-N |
| 0.0115 | 0.0010 | 0.0016 | 0.0036 | 0.0031 | 0.0026 |

From the exemplary Table 1, it may be observed that the second soft sensor 310-2 (configured by the RF-based model) has the least MSE, thus indicating that the test conformance metric generated by the second soft sensor 310-2 may be the most proximate to the historical conformance metric.

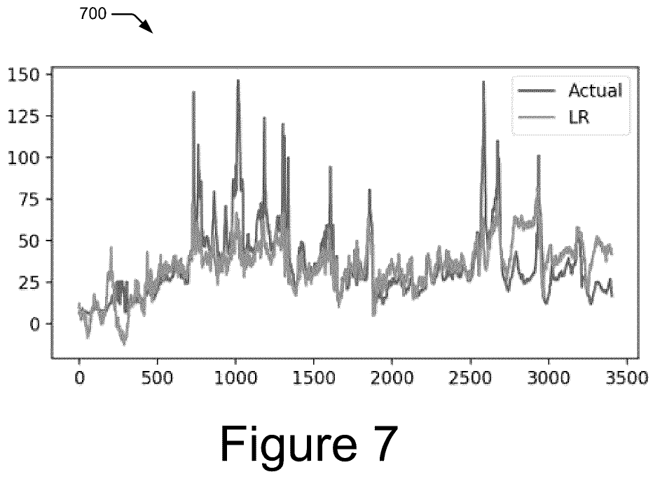

The accuracy or proximity of the test conformance metric, as compared to the historical conformance metric, has been exemplarily illustrated in FIG. 7. FIG. 7 illustrates a line graph 700 illustrating a comparison between the historical conformance metric and the test conformance metric, according to one example implementation of the present subject matter. For the line graph illustrations, multiple test conformance metrics may be generated, by the second soft sensor 310-2, over a period of time to observe accuracy of the second soft sensor 310-2. From the line graph 700, it may be evident that line indicated as “Actual” (the historical conformance metric) and line indicated as “RF” (test conformance metric) may overlap at multiple instances, thereby indicating proximity or similarity between the test conformance metric and the historical conformance metric.

In one example, the MSE of each of the soft sensors 310 may be communicated by the inferential modeler(s) 302 to the processor 104 of the system 102. Based on the MSE, the processor 104 may select the soft sensor having the lowest MSE. The processor 104 may thus select the second soft sensor 310-2 for deployment and prediction of further conformance metrics during runtime of the industrial process. The further conformance metric may thus be referred to as the runtime conformance metric.

In one example implementation, the soft sensor, i.e., the second soft sensor 310-2 may be deployed, on a hardware or software platform associated with the process industry, for predicting the runtime conformance metric. In another example implementation, the machine learning engine or the deep learning engine model that generated the soft sensor 310 may be deployed for predicting the runtime conformance metric. For example, the trained RF-based model may be loaded in a pickel file and the file may be uploaded on a hardware or software platform associated with the process industry. When the file may be called or executed, the RF-based model may render the second soft sensor 310-2 and predict the runtime conformance metric. In another example, the processor 104, of the system 102, may be associated with the process industry and may deploy the second soft sensor 310-2 or the RF-based module on the processor 104 itself for predicting the runtime conformance metric.

In one example, the runtime conformance metric may correspond to the historical conformance metric. That is, the predictions being generated by the second soft sensor 310-2, i.e., the runtime conformance metric, may not be outlier as compared with the historical conformance metric.

Therefore, the present subject matter may disclose a system 102 for conditioning the process variables and, using the conditioned process variables data, configure one or more soft sensors that may accurately be able to predict the runtime conformance metric. Further, the system 102 may automatically identify the most accurate soft sensor for deployment based on the process variables. Also, using the machine learning and the deep learning models, the system 102 may be able to capture complex nonlinear relationships between input process variables and the output runtime conformance metrics, such as process quality variables.

Further, in one example, the selected soft sensor(s) 310, or the machine learning engine or the deep learning engine that configured the selected soft sensor(s) 310, may automatically be deployed. User, such as the one or more users 106-3 may no longer be required to select and the required soft sensor.

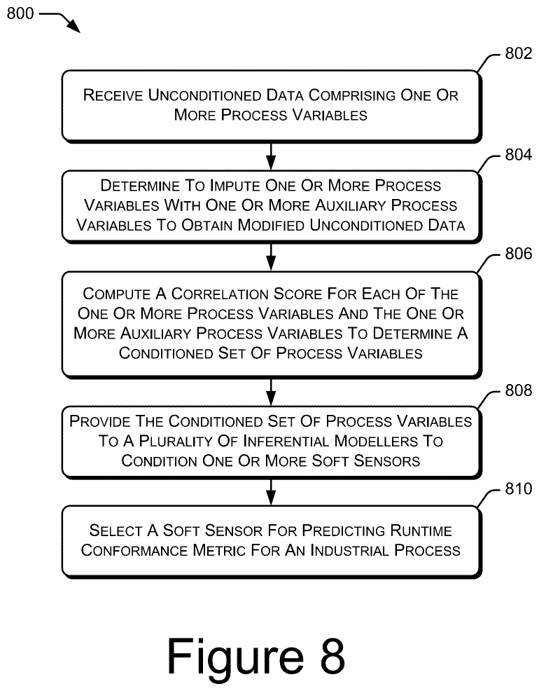

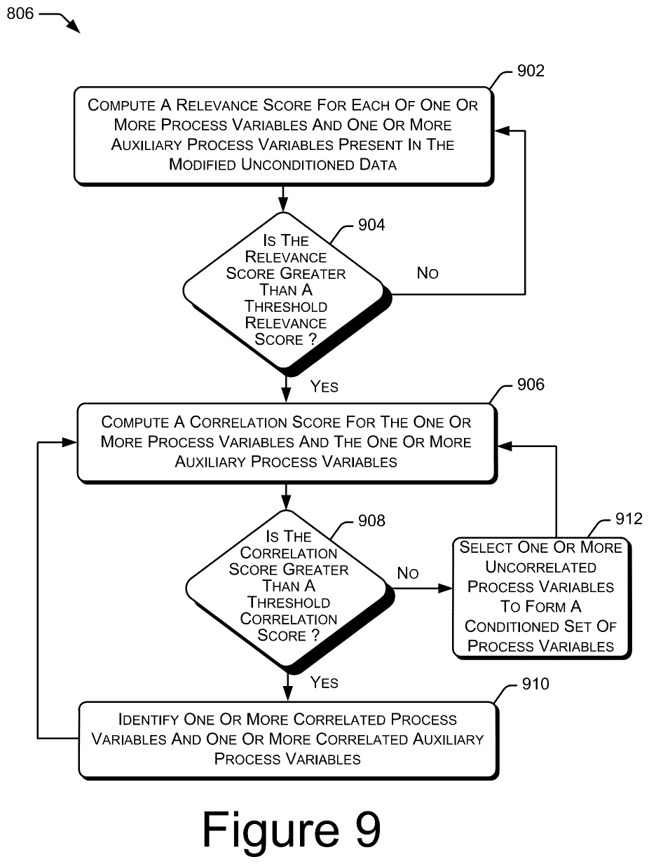

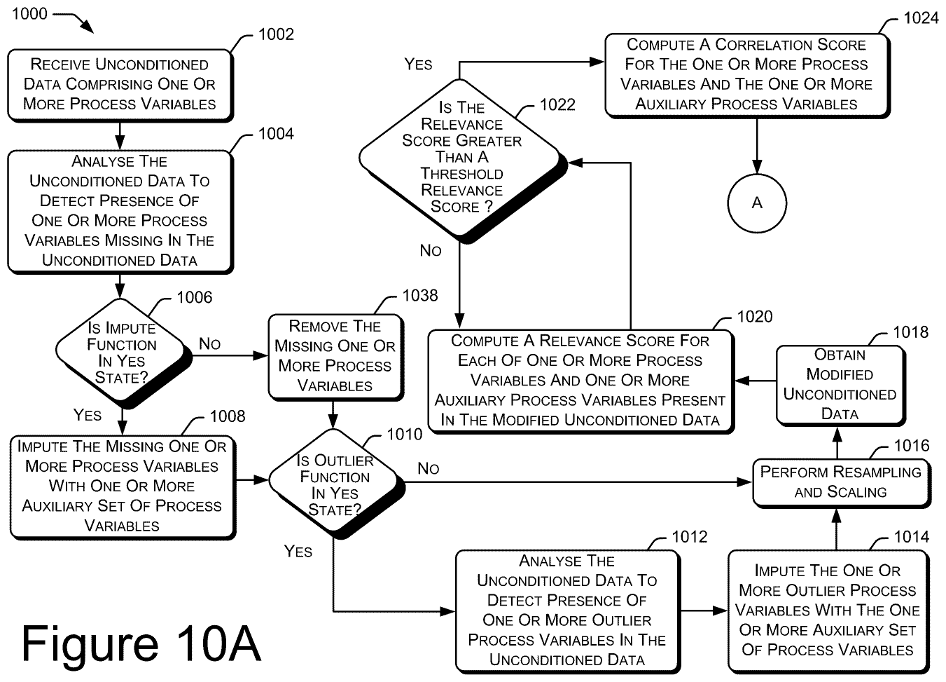

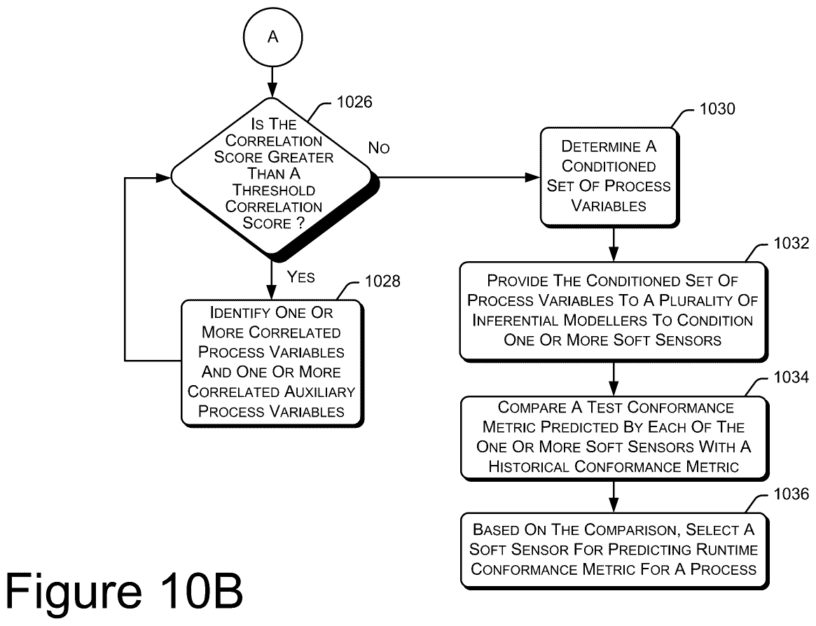

FIGS. 8, 9, and 10 (comprising FIGS. 10A and 10B) illustrate exemplary methods 800, 806, and 1000 respectively, to condition data and configure one or more sensors for predicting runtime conformance metric. The order in which the methods are described is not intended to be construed as a limitation, and any number of the described method blocks may be combined in any order to implement the methods, or an alternative method. Furthermore, methods 800, 806, and 1000 may be implemented by processing resource or computing device(s) through any suitable hardware, non-transitory machine-readable instructions, or a combination thereof.

It may also be understood that methods 800, 806, and 1000 may be performed by programmed computing devices, such as the processor 104, as depicted in FIGS. 1-3. Furthermore, the methods 800, 806, and 1000 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 800, 806, and 1000 are described below with reference to the processor 104 and the system 102 as described above; other suitable systems for the execution of these methods may also be utilized. Additionally, implementation of these methods is not limited to such examples.

FIG. 8 illustrates the method 800 for conditioning data for configuring one or more soft sensors, according to an example implementation of the present subject matter. In one example, the data may include one or more process variables indicating one or more characteristics associated with an industrial process.

At block 802, unconditioned data comprising one or more process variables may be received. In one example, the one or more process variables may be one or more data points. Each of the one or more process variables may indicate, in one example, a numerical value or measurement of at least one characteristic associated with an industrial process. Examples of the characteristics may include, but are not limited to, temperature, pressure, flow rate, weight, density, and humidity. In another example, the process variables may be categorical process variables. The categorical process variables may indicate, for example, type of a material and open/close state of a valve. The unconditioned data may be received from a plurality of data sources, for example, the plurality of data sources 106. In another example, the unconditioned data may be received from a data repository, such as the data repository 108.

At block 804, it may be determined whether one or more process variables are to be imputed with one or more auxiliary process variables to obtain modified unconditioned data. In one example, the determination may be based on an impute state of an impute function. If the impute function has a YES state, it may be determined that one or more process variables may be imputed with one or more auxiliary process variables. In one example, the imputation may be performed by using a decision tree-based algorithm. On imputing the one or more auxiliary process variables, the modified unconditioned data may be obtained. However, if the impute function has a NO state, it may be determined that one or more process variables may be removed from the unconditioned data.

At block 806, a correlation score for each of the one or more process variables and the one or more auxiliary process variables may be computed to determine a conditioned set of process variables. In one example, to compute the correlation score, the one or more process variables and the one or more auxiliary process variables relevant to being used in modelling one or more soft sensors may be identified. The correlation score may then be computed for each of the one or more process variables and the one or more auxiliary process variables, identified to be relevant. In one example, the correlation score may indicate an extent of correlation between each of the one or more process variables and the one or more auxiliary process variables present in the modified unconditioned data. Based on the correlation score, one or more uncorrelated process variables may be identified. A conditioned set of process variables comprising the one or more uncorrelated process variables may be obtained.

At block 808, the conditioned set of process variables may be provided to a plurality of inferential modellers to condition one or more soft sensors. In one example, the plurality of inferential modellers, such as multiple inferential modeller(s) 302, may be provided with the conditioned set of process variables. In one example, the plurality of inferential modellers may include one or more machine learning engines and deep learning engines for conditioning the one or more soft sensors, such as the soft sensor(s) 310. The inferential modellers may condition the one or more soft sensors to build relationships between the process variables present in the conditioned set of process variables and laboratory analysis data, such as the laboratory analysis data 106-2.

At block 810, a soft sensor may be selected for predicting runtime conformance metric for the industrial process. In one example, a soft sensor may be selected from among the one or more soft sensors based on validating the performance of each of the one or more sensors. The performance of each of the one or more soft sensors may be validated based on a test conformance metric determined by each of the one or more soft sensors based on the relationships built between the conditioned set of process variables and the laboratory analysis data. The selected soft sensor may then be used for predicting the runtime conformance metric associated with an outcome of the industrial process. In one example, the runtime conformance metric may indicate a quality of a product (outcome of the industrial process).

FIG. 9 illustrates a detailed explanation of the block 806 for identifying relevant process variables by performing the correlation analysis, according to an example implementation of the present subject matter.

At block 902, a relevance score for each of the one or more process variables and the one or more auxiliary sets of process variables present in the modified unconditioned data. In one example, the relevance score may be computed using a decision tree-based algorithm. The relevant score may indicate suitability of each of the one or more process variables and the one or more auxiliary process variables for being used in modelling the one or more soft sensors.

At block 904, it may be determined whether the relevance score is more than a threshold relevance score. In one example, the relevance score of each of the one or more process variables and the one or more auxiliary process variables may be compared with the threshold relevance score. The one or more process variables and the one or more auxiliary process variables having the relevance score greater than the threshold relevance score may be identified to be relevant, and the method may follow the YES path and proceed to block 906.

At block 906, a correlation score may be computed for the one or more process variables and the one or more auxiliary process variables. In one example, the correlation score may be computed for the one or more process variables and the one or more auxiliary process variables, that may be present in the modified unconditioned data and have the relevance score more than the threshold relevance score. In one example, the correlation score may be computed by statistical analysis of each of the one or more process variables and the one or more auxiliary process variables. The correlation score may indicate an extent of correlation for the one or more process variables and the one or more auxiliary process variables present in the modified unconditioned data.

At block 908, it may be determined whether the correlation score is more than a threshold correlation score. In one example, the correlation score computed for each of the one or more process variables and the one or more auxiliary process variables may be compared with the threshold correlation score. If the correlation score is determined to be more than the threshold score, the method may follow the YES path and proceed to block 910.

At block 910, one or more correlated process variables and one or more correlated auxiliary process variables may be identified. In one example, the process variables and the auxiliary process variables having a correlation score more than the threshold correlation score may be identified as the correlated process variables and the correlated auxiliary process variables. Such process variables and auxiliary process variables may be considered as highly correlated and may thus be filtered from the modified unconditioned data.

However, if at block 908, it is determined that the correlation score is less than the threshold score, the method may follow the NO path and proceed to block 912.

At block 912, one or more uncorrelated process variables may be selected to form a conditioned set of process variables. In one example, if the correlation score of the one or more process variables and the one or more auxiliary process variables is less than the threshold correlation score, it may be ascertained that such process variables and auxiliary process variables may not be highly correlated, or uncorrelated. Such process variables and auxiliary process variables may be selected as the uncorrelated process variables and the conditioned set of process variables may thus be formed.

However, if at block 904, it is determined that the relevance score is less than the threshold relevance score, the method may follow the NO path and proceed to block 902.

FIG. 10 (comprising FIGS. 10A and 10B) illustrates the method 1000 for conditioning data for configuring one or more soft sensors, according to one example implementation of the present subject matter.

At block 1002, unconditioned data comprising one or more process variables may be received. In one example, the one or more process variables may be data points, each being associated with at least one characteristic of an industrial process. For example, the data points may be indicative of a value or measurement of the at least one characteristic or operational parameter associated with the industrial process. In one example, the unconditioned data may be received by a processor, such as the processor 104.

At block 1004, the unconditioned data may be analysed to detect presence of one or more process variables missing in the unconditioned data. In one example, the missing process variables may be missing data points. For example, the processor 104 may analyse the unconditioned data for detecting presence of NaNs, NA, and other special characters. If such characters are detected within the unconditioned data, it may be ascertained that the one or more process variables may be missing in the unconditioned data.

At block 1006, it may be determined whether an impute function is in YES state. In one example, an impute state of the impute function may be determined. The impute state may define whether the one or more process variables missing in the unconditioned data are to be imputed. If the impute state is determined to be YES, the method may follow the YES path and proceed to block 1008.

At block 1008, the one or more process variables may be imputed with one or more auxiliary set of process variables. In one example, the one or more process variables missing in the unconditioned data may be imputed with the one or more auxiliary set of process variables. The auxiliary set of process variables may be, in one example, statistically determined. In another example, the auxiliary set of process variables may be determined using an ensemble-based algorithm.

At block 1010, it may be determined whether an outlier function is in YES state. In one example, an outlier state of the outlier function may be determined. The outlier state may define whether the unconditioned data is to be analysed for outlier process variables. If the outlier state is determined to be YES, the method may follow the YES path and proceed to block 1012.

At block 1012, the unconditioned data may be analysed to detect presence of one or more outlier process variables in the unconditioned data. In one example, the one or more outlier process variables may be data points that may be anomalous or inconsistent with the other process variables, or data points, present in the unconditioned data. In one example, presence of the outlier process variables may be detected by using a tree-based algorithm.

At block 1014, the one or more outlier process variables may be imputed with the one or more auxiliary set of process variables.

At block 1016, resampling and scaling may be performed. In one example, the one or more process variables and the one or more auxiliary process variables may be resampled based on a resampling factor. The resampling may, in one example, arrange the one or more process variables and the one or more auxiliary process variables into one or more subsets. Further, in one example, each of the one or more subsets may be scaled based on a scaling factor for being compatible for further processing and computing a correlation score.

At block 1018, modified unconditioned data may be obtained. In one example, once the resampling and scaling has been done, the modified unconditioned data may be obtained. The modified unconditioned data may include, for example, the resampled and scaled one or more process variables and the one or more auxiliary process variables.

At block 1020, a relevance score may be computed for each of the one or more process variables and the one or more auxiliary process variables present in the modified unconditioned data. In one example, the relevance score may indicate suitability of each of the process variables and the auxiliary process variables for being used in modelling one or more soft sensors, such as the soft sensor(s) 310. The relevance score may be computed, in one example, using a tree-based algorithm.

At block 1022, it may be determined whether the relevance score is greater than a threshold relevance score. In one example, the relevance score computed for each of the one or more process variables and the one or more auxiliary process variables may be compared with the threshold relevance score. If it is determined that the relevance score is greater than the threshold relevance score, the method may follow the YES path and proceed to block 1024.

At block 1024, a correlation score may be computed for the one or more process variables and the one or more auxiliary process variables. In one example, the correlation score may be computed for the process variables and the auxiliary process variables, that are present in the modified unconditioned data and have the relevance score more than the threshold relevance score. In one example, the correlation score may be determined by performing a statistical analysis of each of the process variables and the auxiliary process variables. The correlation score may indicate a correlation between each of the process variables and the auxiliary process variables present in the modified unconditioned data.

The method may further proceed to block A and may continue as exemplarily illustrated in FIG. 10B.

At block 1026, it may be determined whether the correlation score is more than a threshold correlation score. In one example, the correlation score computed for each of the process variables and the auxiliary process variables may be compared with the threshold correlation score. If the correlation score is determined to be more than the threshold score, the method may follow the YES path and proceed to block 1028.

At block 1028, one or more correlated process variables and one or more correlated auxiliary process variables may be identified. In one example, the process variables and the auxiliary process variables having correlation score more than the threshold correlation score may be identified as the correlated process variables and the correlated auxiliary process variables. Such process variables and auxiliary process variables may be considered as highly correlated and may be redundantly present in the modified unconditioned data. Such process variables and auxiliary process variables may thus be identified in the modified unconditioned data.

However, if at block 1026, it is determined that the correlation score is less than the threshold correlation score, the method may follow the NO path and proceed to block 1030.

At block 1030, a conditioned set of process variables may be determined. In one example, the process variables and the auxiliary process variables having correlation score lesser than the threshold correlation score may be identified as uncorrelated process variables. The uncorrelated process variables may be selected to form the conditioned set of process variables.

At block 1032, the conditioned set of process variables may be provided to a plurality of inferential modellers to condition one or more soft sensors. In one example, the plurality of inferential modellers may include one or more machine learning engines and deep learning engines for conditioning the one or more soft sensors, such as the one or more soft sensor(s) 310. The plurality of inferential modellers may condition the one or more soft sensors to indicate relationships between the process variables present in the conditioned set of process variables and the laboratory analysis data comprising the historical conformance metric. In one example, the historical conformance metric may be associated with one or more past observed outcomes of the industrial process.

At block 1034, a test conformance metric predicted by each of the one or more sensors may be compared with the historical conformance metric. In one example, once the one or more soft sensors are conditioned, the one or more soft sensors may be provided with a test subset, comprising one or more process variables, to evaluate performance of each of the configured soft sensors. On receiving the test subset, each of the one or more soft sensors may generate or predict the test conformance metric.

At block 1036, select a soft sensor for predicting runtime conformance metric for the industrial process. In one example, the test conformance metric predicted by each of the one or more soft sensors may be compared with the historical conformance metric to validate the one or more soft sensors. The soft sensor that predicted the test conformance metric most proximate to the historical conformance metric may be selected. The selected soft sensor may then be deployed for predicting the runtime conformance metric for the industrial process. In one example, the runtime conformance metric may be associated with an outcome of the industrial process. For example, the runtime conformance metric may be associated with a quality of the industrial process being implemented in the process industry. In another example, the runtime conformance metric may indicate a quality of a product or a process being implemented in the process industry. The soft sensor may, in one example, predict the runtime conformance metric in real time.

However, if at block 1022, it is determined that the relevance score is not greater than the threshold relevance score, the method may follow the NO path and proceed to block 1020.

However, if at block 1010, state of the outlier function is determined to be NO, the method may follow the NO path and proceed to block 1016. In one example, NO state of the outlier function may indicate that the outlier detection is not to be performed. The outlier function may thus restrict detecting presence of the one or more outlier process variables in the unconditioned data.

However, if at block 1006, it is determined that state of the impute function is NO, the method may follow the NO path to block 1038.

At block 1038, the one or more missing process variables may be removed. In one example, instead of imputing the missing process variables with the auxiliary process variables, the missing process variables may be removed from the unconditioned data. The modified unconditioned data may thus be obtained after removing the missing process variables.

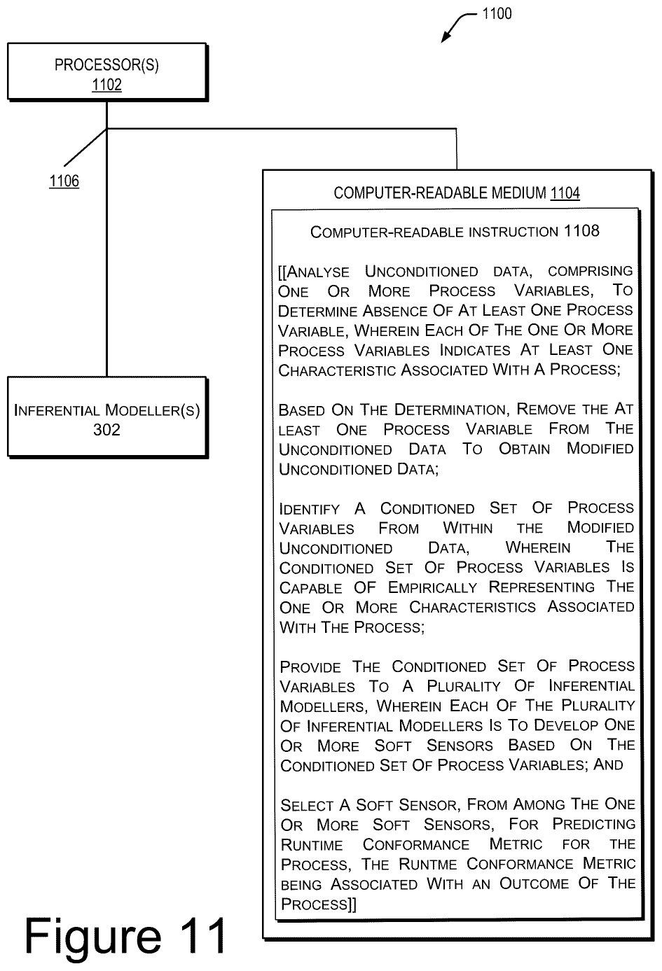

FIG. 11 illustrates a computing environment 1100 implementing a non-transitory computer readable medium for modelling one or more soft sensors, according to an example implementation of the present subject matter. In one example, the computing environment 1100 includes processor(s) 1102 communicatively coupled to a non-transitory computer readable medium 1104 through a communication link 1106. In an example implementation, the computing environment 1100 may be for example, the computing environment 300. In an example, the processor(s) 1102 may have one or more processing resources for fetching and executing computer-readable instructions from the non-transitory computer readable medium 1104. The processor(s) 1102 and the non-transitory computer readable medium 1104 may be implemented, for example, in the processor 104 (as has been described in conjunction with the preceding figures).

The non-transitory computer readable medium 1104 may be, for example, an internal memory device or an external memory device. In an example implementation, the communication link 1106 may be a network communication link. The processor(s) 1102 and the non-transitory computer readable medium 1104 may also be communicatively coupled to a plurality of inferential modeler(s) 302 over the communication link 1106.

In an example implementation, the non-transitory computer readable medium 1104 may include a set of computer readable instructions 1108 which may be accessed by the processor(s) 1102 through the communication link 1106. Referring to FIG. 11, in an example, the non-transitory computer readable medium 1104 may include instructions 1108 that may cause the processor(s) 1102 to analyse unconditioned data, comprising one or more process variables. Each of the one or more process variables may indicate, for example, at least one characteristic associated with a process. In one example, the unconditioned data may be analysed to determine absence of at least one process variable. As previously described, the unconditioned data may be analysed to detect missing process variables. Based on the determination, at least one process variable may be removed from the unconditioned data to obtain modified unconditioned data.

In one example, in addition to removal of missing process variables, at least one outlier process variable may also be removed. In one example, the non-transitory computer readable medium 1104, to remove the at least one process variable from the unconditioned data, may include instructions 1108 that may cause the processor(s) 1102 to detect presence of at least one outlier process variable within the unconditioned data. The at least one outlier process variable, for example, may be anomalous from the other process variables present in the unconditioned data. The at least one outlier process variable may be detected based on ascertaining the anomality of the one or more process variables. In one example, the anomality may be ascertained by statistically analysing each of the process variables present in the unconditioned data. Based on the analysis, it may be determined to remove the at least one outlier process variable from the unconditioned data to obtain the modified unconditioned data.

Further, the non-transitory computer readable medium 1104 may include instructions 1108 that may cause the processor(s) 1102 to identify a conditioned set of process variables from within the modified unconditioned data. In one example, the conditioned set of process variables may be capable of empirically representing the one or more characteristics associated with the process. In one example, the non-transitory computer readable medium 1104, to identify the conditioned set of process variables, may include instructions 1108 that may cause the processor(s) 1102 to perform a correlation analysis to compute a correlation score for each of the one or more process variables present in the modified unconditioned data. The correlation score is to indicate, in one example, a correlation among the one or more process variables present in the modified unconditioned data. In one example, the correlation score may be computed by statistically analysing relationships between each of the one or more process variables present in the modified unconditioned data.

The correlation score of each the one or more process variables may be compared with a threshold correlation score to identify one or more uncorrelated process variables present in the modified unconditioned data. In one example, the one or more process variables having the correlation score less than the threshold correlation score may be identified as the uncorrelated process variables. Such uncorrelated process variables may be selected from the modified unconditioned data to obtain the conditioned set of process variables.

Further, the non-transitory computer readable medium 1104 may include instructions 1108 that may cause the processor(s) 1102 to provide the conditioned set of process variables to a plurality of inferential modellers, such as the inferential modeller(s) 302. In one example, the conditioned set of process variables may be provided to develop one or more soft sensors based on the conditioned set of process variables. In one example, the plurality of inferential modeller(s) 302 may include one or more machine learning engine(s) and deep learning engine(s), such as the machine learning engine(s) 306 and deep learning engine(s) 308. The machine learning engine(s) 306 and deep learning engine(s) 308 may condition the one or more soft sensors, such as the soft sensor(s) 310. In one example, the one or more soft sensors 310 may be conditioned to develop relationships between the process variables present in the conditioned set of process variables and the laboratory analysis data 106-2, comprising the historical conformance metric. In one example, the historical conformance metric may be associated with one or more past observed outcomes of the process.

The non-transitory computer readable medium 1104 may include instructions 1108 that may further cause the processor(s) 1102 to select a soft sensor, from among the one or more soft sensor(s) 310, for predicting runtime conformance metric for the process. In one example, each of the soft sensor(s) 310 may generate a test conformance metric. The soft sensor that generated a test conformance metric most proximate to the historical conformance metric may be selected. The selected soft sensor may then be deployed for predicting the runtime conformance metric for the process. In one example, the runtime conformance metric may be associated with an outcome of the industrial process.

The soft sensor may, in one example, predict the runtime conformance metric during runtime of the process. For example, when deployed in the process industry, the soft sensor may receive one or more process variables, indicating at least one characteristic associated with the process being implemented in the process industry. Based on the received process variables, the soft sensor may predict the runtime conformance metric associated with the outcome of the process. For example, the runtime conformance metric may indicate a quality of a product or a process being implemented in the process industry.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor to:
receive unconditioned data comprising a set of process variables, wherein the set of process variables is indicative of one or more characteristics associated with a process;
supplement the unconditioned data with an auxiliary set of process variables to obtain modified unconditioned data, the auxiliary set at least comprising a process variable missing in the unconditioned data;
identify a conditioned set of process variables from within the modified unconditioned data, wherein the conditioned set of process variables is capable of empirically representing the one or more characteristics associated with the process;
provide the conditioned set of process variables to a plurality of inferential modellers, wherein each of the inferential modellers is to configure one or more soft sensors based on the conditioned set of process variables; and
select a soft sensor, from among the one or more soft sensors, for being deployed to predict runtime conformance metric for the process, the runtime conformance metric being associated with an outcome of the process.

2. The system of claim 1, wherein the processor is to:
compute a correlation score for one or more process variables present in the modified unconditioned data, the correlation score being computed by statistical analysis of relationships between each of the one or more process variables;
compare the correlation score of each the one or more process variables with a threshold correlation score to identify one or more uncorrelated process variables present in the modified unconditioned data; and
based on the comparison, select the one or more uncorrelated process variables, from the modified unconditioned data, to form the conditioned set of process variables.

3. The system of claim 2, wherein the processor is to:
ascertain presence of at least one outlier process variable within the set of process variables, wherein the at least one outlier process variable is anomalous from other one or more process variables present in the set of process variables, and wherein the anomaly is ascertained by statistically analysing each of the process variables present in the set of process variables; and
supplement the unconditioned data with the auxiliary set of process variables, in response to the ascertaining the presence of the anomaly.

4. The system of claim 1, wherein the one or more soft sensors is to represent a relationship between the set of process variables and the runtime conformance metric.

5. The system of claim 4, wherein the plurality of inferential modellers configure each of the one or more soft sensors based on a historical conformance metric, the historical conformance metric corresponding to the runtime conformance metric.

6. The system of claim 5, wherein the processor is to:
compare a test conformance metric, predicted by each of the soft sensors based on the conditioned set of process variable, with the historical conformance metric to validate the one or more soft sensors, wherein the historical conformance metric is associated with one or more past observed outcomes of the process; and
based on the comparison, select the soft sensor, from among the one or more soft sensors.

7. A method comprising:
receiving unconditioned data comprising one or more process variables, each indicating at least one characteristic associated with an industrial process;
determining to impute one or more process variables, from among the one or more process variables present in the unconditioned data, with one or more auxiliary process variables to obtain modified unconditioned data;
computing a correlation score for each of the one or more process variables and the one or more auxiliary process variables, present in the modified unconditioned data, to determine a conditioned set of process variables, wherein the conditioned set of process variables is capable of representing the at least one characteristic associated with the industrial process;
providing the conditioned set of process variables to a plurality of inferential modellers, wherein each of the inferential modellers is to condition one or more soft sensors based on the conditioned set of process variables; and
selecting a soft sensor, from among the one or more soft sensors, for predicting runtime conformance metric for the process, the runtime conformance metric being associated with an outcome of the industrial process.

8. The method of claim 7, wherein the determining to impute the one or more process variables comprises:
determining an impute state of an impute function, wherein the impute state comprises:
a YES state to indicate the impute function to allow imputing the one or more process variables with the one or more auxiliary process variables; and
a NO state to indicate the impute function to restrict imputing the one or more process variables with the one or more auxiliary process variables.

9. The method of claim 8, the method further comprising:
on ascertaining the impute state to be the YES state, imputing the one or more process variables with the one or more auxiliary process variables to obtain the modified unconditioned data, the one or more auxiliary process variables at least comprising a process variable missing in the unconditioned data; and
on ascertaining the impute state to be the NO state, removing the one or more process variables from the unconditioned data to obtain the modified unconditioned data.

10. The method of claim 9, wherein the determining to impute the one or more process variables further comprises:
determining an outlier state of an outlier function, wherein the outlier state comprises:
a YES state to indicate the outlier function to allow detecting presence of one or more outlier process variables among the one or more process variables present in the unconditioned data, wherein the one or more outlier process variables are process variables which are inconsistent with the other process variables present in the unconditioned data; and
a NO state to indicate the outlier function to restrict detecting presence of the one or more outlier process variables.

11. The method of claim 10, the method further comprising replacing the one or more outlier process variables with the one or more auxiliary process variables on ascertaining the outlier state to be the YES state.

12. The method of claim 7, the method further comprising resampling the one or more process variables and the one or more auxiliary process variables, based on a resampling factor, for arranging the one or more process variables and the one or more auxiliary process variables into one or more subsets.

13. The method of claim 12, the method further comprising scaling each of the one or more subsets, based on a scaling factor, to be compatible for computing the correlation score.

14. The method of claim 7, wherein computing the correlation score comprises:
performing a statistical analysis to determine a correlation between each of the one or more process variables and the one or more auxiliary process variables present in the modified unconditioned data;
based on the statistical analysis, obtaining the correlation score indicating an extent of correlation for the one or more process variables and the one or more auxiliary process variables present in the modified unconditioned data;
comparing the correlation score, of each the one or more process variables and the one or more auxiliary process variables, with a threshold correlation score to identify one or more uncorrelated process variables present in the modified unconditioned data; and
based on the comparison, selecting the one or more uncorrelated process variables, from the modified unconditioned data, to form the conditioned set of process variables.

15. The method of claim 7, wherein to determine the conditioned set of process variables, the method further comprises:
determining a relevance score for each of the one or more process variables and the one or more auxiliary process variables present in the modified unconditioned data, the relevance score indicating suitability of each of the one or more process variables and the one or more auxiliary process variables for being used in modelling the one or more soft sensors;
comparing the relevance score of each of the one or more process variables and the one or more auxiliary process variables with a threshold relevance score; and
based on the comparison, identifying one or more process variables, from among the one or more process variables and the one or more auxiliary process variables, suitable for being used in modelling the one or more soft sensors.

16. A non-transitory computer-readable medium comprising instructions for modeling one or more soft sensors, the instructions being executable by a processing resource to:
analyse unconditioned data, comprising one or more process variables, to determine absence of at least one process variable, wherein each of the one or more process variables indicates at least one characteristic associated with a process;
based on the determination, remove the at least one process variable from the unconditioned data to obtain modified unconditioned data;
identify a conditioned set of process variables from within the modified unconditioned data, wherein the conditioned set of process variables is capable of empirically representing the at least one characteristics associated with the process;
provide the conditioned set of process variables to a plurality of inferential modellers, wherein each of the inferential modellers is to develop one or more soft sensors based on the conditioned set of process variables; and
select a soft sensor, from among the one or more soft sensors, for predicting runtime conformance metric for the process, the runtime conformance metric being associated with an outcome of the process.

17. The non-transitory computer-readable medium of claim 16, wherein to identify the conditioned set of process variables, the instructions are executable by the processing resource to:
perform a correlation analysis to compute a correlation score for each of the one or more process variables present in the modified unconditioned data, wherein the correlation score is to indicate a correlation among the one or more process variables, the correlation score being computed by statistical analysis of relationships between each of the one or more process variables present in the modified unconditioned data;
compare the correlation score of each the one or more process variables with a threshold correlation score to identify one or more uncorrelated process variables present in the modified unconditioned data; and
based on the comparison, select the one or more uncorrelated process variables, from the modified unconditioned data, to obtain the conditioned set of process variables

18. The non-transitory computer-readable medium of claim 16, wherein to remove the at least one process variable from the unconditioned data, the instructions are executable by the processing resource to:
detect presence of at least one outlier process variable within the unconditioned data, wherein the at least one outlier process variable is anomalous from the other one or more process variables present in the unconditioned data, and wherein the anomality is ascertained by statistically analysing each of the process variables present in the unconditioned data; and
based on the analysis, determine to remove the at least one outlier process variable from the unconditioned data to obtain the modified unconditioned data.

19. The non-transitory computer-readable medium of claim 16, wherein the instructions are executable by the processing resource to:
predict a test conformance metric, by the one or more soft sensors, based on the conditioned set of process variables;
compare the test conformance metric, predicted by the one or more soft sensors, with one or more historical conformance metrics, wherein the one or more historical conformance metrics is associated with one or more past observed outcomes of the process; and
based on the comparison, select the soft sensor, from among the one or more soft sensors.

20. The non-transitory computer-readable medium of claim 19, wherein the soft sensor is to predict the runtime conformance metric during runtime of the process.
